(19) United States
(12) Patent Application Publication
(10) Pub. No.: US 2014/0174406 A1
(43) Pub. Date: Jun. 26, 2014

(54) CONTROL SYSTEM FOR AN ENGINE WITH EGR FLOW

(71) Applicant: CATERPILLAR, INC., Peoria, IL (US)

(72) Inventor: Jason Jon Rasmussen, Hopewell, IL (US)

(73) Assignee: CATERPILLAR, INC., Peoria, IL (US)

(21) Appl. No.: 13/722,592

(22) Filed: Dec. 20, 2012

(51) Int. Cl. F02M 25/07

(52) U.S. Cl. CPC F02M 25/077
USPC 123/478

(57) ABSTRACT

A system associated with an internal combustion engine is disclosed. The system may be configured to inject fuel at a current fuel injection flow rate and to direct exhaust at a current EGR flow rate. A controller may be configured to determine a maximum fuel injection flow rate and a maximum EGR flow rate based on a first and second group of operating parameters, wherein the first and second group may comprise at least common operating parameter including an oxygen-to-fuel ratio limit. Additionally, the controller may set the current fuel injection flow rate to the maximum fuel injection if a fuel injection flow request, associated with a fuel injector, is greater than the maximum fuel injection flow rate and set the current EGR flow rate to the maximum EGR flow rate if an EGR flow request, associated with an EGR valve, is greater than the maximum EGR flow rate.

### TECHNICAL FIELD

The present disclosure is directed to a control system, and more particularly, to a control system for an engine with exhaust gas recirculation (EGR) flow.

### BACKGROUND

Internal combustion engines, such as for example diesel engines, gasoline engines, and gaseous fuel powered engines are supplied with a mixture of air and fuel. An intake manifold delivers air to the engine, while a fuel injection system injects fuel into the combustion chamber. The air and fuel mix within the combustion chamber, and the mixture combusts to produce mechanical energy that drives the engine. Exhaust gas, emitted from the engine as a result of the combustion, is directed through an exhaust manifold. This emitted exhaust gas may re-circulate back to the engine, through an exhaust gas recirculation (EGR) system, and may assist in minimizing the amount of nitrogen oxides and other harmful pollutants in the exhaust. However, the engine must balance the amount of exhaust gas re-circulated through the EGR and the amount of fuel injected with the supplied air to maintain a desired oxygen-to-fuel ratio for combustion.

A control system may control the rate of exhaust gas flowing through the EGR system, the air supplied by the intake manifold, and the amount of fuel injected to maintain a desired oxygen-to-fuel ratio. Conventional control systems utilize two modes of operation wherein EGR flow is either modulated, based on desired inlet manifold composition, or fully-closed during acceleration events. The EGR system is opened when more exhaust gas is needed to balance the oxygen-to-fuel ratio and conversely closed when less exhaust gas is needed. The conventional control systems regulate the amount of oxygen supplied by the intake manifold and the amount of fuel injected by fuel injectors and compare these amounts with a predetermined threshold. EGR flow is fully-closed when the oxygen level is below the threshold amount and opened when the oxygen level is at or above this threshold.

U.S. Pat. No. 7,155,332 B2 that issued to Yamada et al. on Dec. 26, 2006 (the '332 patent), discloses one such conventional processing system for an engine. The processing system of the '332 patent calculates a ratio of the amount of oxygen supplied by the intake manifold versus the fuel injection quantity. This ratio is then compared with a target oxygen concentration, a threshold value, to determine if enough air is present in the engine. Based on these calculations, the EGR system is either opened or fully-closed.

The processing system of the '332 patent may be configured to adjust EGR flow to the engine during rapid acceleration events when there is a sharp decline in the amount of oxygen in the intake manifold compared to fuel demand. For example, during a rapid acceleration event, the EGR valve described in the '332 patent completely closes until the oxygen-to-fuel ratio is balanced again. However, the system of the '332 patent is not responsive to relatively small changes in oxygen and/or fuel demand. Such changes may occur, for example, when an operator makes relatively small changes in the position of a machine accelerator pedal or lever, causing only a small decrease in intake manifold oxygen and/or fuel demand. In such situations, the processing system of the '332 patent may completely eliminate all EGR flow even though only a small decrease in oxygen quantity and/or fuel is needed. Therefore, the EGR system of the '332 patent may close for only a small amount of time before it is re-opened. Such opening and closing may occur frequently when an operator continuously changes speed, which may be wearing on the EGR system and produce a shortened life. Additionally, the continuous opening and closing may result in inefficient operation of the system.

Furthermore, the engine of the '332 patent may be difficult to calibrate. Many factors are used to determine fuel injection quantity, such as intake manifold pressure, engine speed, and barometric pressure. These engine conditions are put into maps to determine the desired fuel injection quantity. However, such factors may not be intuitive of the fuel injection quantity itself and may require many calculations.

Exemplary embodiments of the present disclosure are directed toward overcoming one or more of the deficiencies associated with the prior art.

### SUMMARY

In one aspect, the present disclosure is directed to a system associated with an internal combustion engine that may include a fuel injector configured to inject fuel into the engine at a current fuel injection flow rate, and an EGR valve configured to direct exhaust to the engine at a current EGR flow rate via an EGR flow path. The system may further include a controller in communication with the EGR valve and the fuel injector. The controller may be configured to determine a maximum fuel injection flow rate based on a first group of operating parameters associated with the engine and determine a maximum EGR flow rate based on a second group of operating parameters associated with the engine. The first and second groups may comprise at least one common operating parameter including an oxygen-to-fuel ratio limit determined based on a speed of the engine. Additionally, the controller may receive a fuel injection flow request associated with the fuel injector and an EGR flow request associated with the EGR valve. The controller may set the current fuel injection flow rate to the maximum fuel injection flow rate if the fuel injection flow request is greater than the maximum fuel injection flow rate. Additionally, the controller may set the current EGR flow rate to the maximum EGR flow rate if the EGR flow request is greater than the maximum EGR flow rate.

In another aspect, the present disclosure is directed to a method of calibrating an internal combustion engine including determining a current oxygen-to-fuel ratio associated with the engine and determining maximum and minimum oxygen-to-fuel ratio limits based on a current speed of the engine. The method may further include modifying a group of engine settings, based on a first set of known relationships associated with steady state emissions conditions, in response to determining that the current oxygen-to-fuel ratio is greater than the maximum oxygen-to-fuel ratio limit. Additionally, the method may include modifying the group of engine settings, based on a second set of known relationships associated with acceleration state emissions conditions, in response to determining that the current oxygen-to-fuel ratio is less than the minimum oxygen-to-fuel ratio limit.

### BRIEF DESCRIPTION OF THE DRAWINGS

FIG. 1 is a diagrammatic illustration of an exemplary disclosed system.

FIG. 2. is a flow chart illustrating a method for regulating fuel injection flow rate and EGR flow rate that may be used with the system of FIG. 1.

FIG. 3 is a flow chart illustrating a method for calibrating the system of FIG. 2.

### DETAILED DESCRIPTION

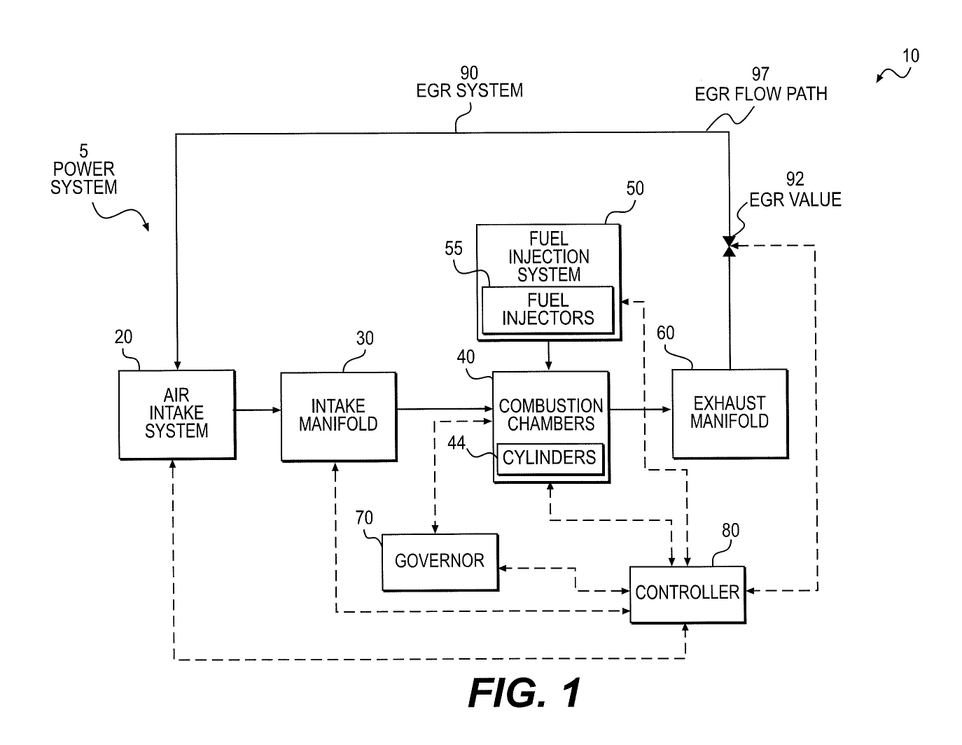

FIG. 1 illustrates a system 10 associated with a machine (not shown) known in the art. The machine may be mobile or stationary and may be configured to perform mining, construction, farming, transportation, power generation, or any other work associated with a particular industry. In some embodiments, the machine may be a mining truck, an off-highway truck, a dozer, a backhoe, an excavator, a motor grader, or any other earth moving machine. The machine may alternatively be a stationary machine including, but not limited to, a stationary generator set, pumping mechanism, or other suitable operation-performing machine.

As shown in FIG. 1, system 10 may include a power system 5 and a control system in communication with one or more components of power system 5. For the purposes of this disclosure, power system 5 is depicted and described as a diesel, gaseous, or fuel-powered internal combustion engine. Power system 5 may include combustion chambers 40 associated with an intake manifold 30 and an exhaust manifold 60. Intake manifold 30 may deliver air to combustion chambers 40, and exhaust manifold 60 may collect the exhaust from combustion chambers 40. An EGR system 90 may be configured to re-circulate the exhaust, from exhaust manifold 60 to air intake system 20, and reduce exhaust emissions.

Air intake system 20 may be fluidly connected to intake manifold 30 and EGR system 90. Specifically, air intake system 20 may mix re-circulated exhaust from EGR system 90 with air received from the atmosphere and deliver this mixture to intake manifold 30. Furthermore, intake manifold 30 may direct the mixture into one or more cylinders 44 of combustion chambers 40.

EGR system 90 may include an EGR valve 92 and an EGR flow path 97. Exhaust gas may be directed through EGR flow path 97 at a current EGR flow rate. The current EGR flow rate may comprise a dynamic operating parameter associated with the engine, such that the current EGR flow rate may be continuously changing during operation of the power system 5. EGR valve 92 may open and close to regulate exhaust flow through EGR flow path 97. Therefore, EGR valve 92 may increase or decrease the current EGR flow rate. In one exemplary embodiment, operation of the EGR valve 92 may be configured to vary from a fully open to a fully closed state, including all partial closed and open states in between. EGR flow path 97 may fluidly connect exhaust manifold 60 with air intake system 20.

Power system 5 may further include a fuel injection system 50 having one or more fuel injectors 55 configured to direct fuel into cylinders 44 within combustion chambers 40. The fuel may mix with the air mixture supplied by intake manifold 30 within cylinders 44. Fuel injectors 55 may comprise a flow component so that they may inject fuel when opened and eliminate flow when closed. Additionally, fuel injection system 50 may further include a valve, spring, plunger, pump, and/or any other known flow control component (not shown) configured to deliver fuel, at a current fuel injection flow rate, into combustion chambers 40. Similar to the current EGR flow rate described above, the current fuel injection flow rate may comprise a dynamic operating parameter associated with the engine, such that the current fuel injection flow rate may be continuously changing during operation of power system 5.

A governor 70 associated with power system 5 may regulate the amount of fuel injected by fuel injection system 50. Specifically, governor 70 may request an amount of fuel for injection based on a torque demand associated with current engine speed. The torque demand may correspond to the position of an accelerator pedal or lever (not shown). Fuel injection system 50 may supply the requested amount of fuel to the combustion chambers 40 in response to the governor request.

The control system may include a controller 80 configured to regulate fluid flow and/or EGR flow rate within power system 5. Specifically, controller 80 may be in communication with the components of power system 5 to determine various engine operating parameters. Controller 80 may regulate a current fuel injection flow rate and a current EGR flow rate based on one or more of these operating parameters.

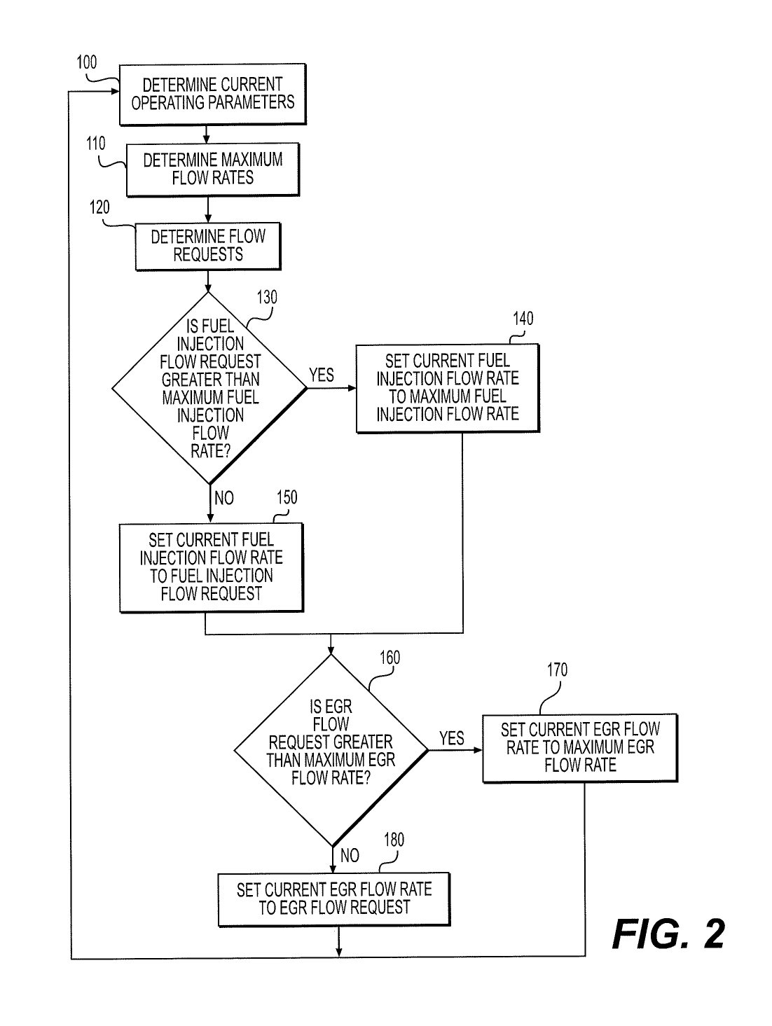

As will be described in greater detail below with respect to FIG. 2, in exemplary embodiments, controller 80 may be configured determine a maximum fuel injection flow rate in a closed-loop manner from a first group of operating parameters associated with power system 5. The maximum fuel injection flow rate may comprise a dynamic operating parameter associated with power system 5 and may represent the maximum amount of allowed fuel injected into combustion chambers 40 based on the current condition of power system 5. Therefore, the maximum fuel injection flow rate may change as one or more parameters of the first group of operating parameters varies during operation of power system 5. Additionally, in exemplary embodiments, the first group of operating parameters described above may include, among other things, an oxygen-to-fuel ratio limit, a total current mass flow, and/or a current EGR flow rate. The oxygen-to-fuel ratio limit may be characterized by an oxygen amount and a fuel amount associated with one or more cylinders 44 of combustion chambers 40. Controller 80 may determine this limit from an oxygen-to-fuel ratio v. engine speed look-up map. Alternatively, controller 80 may determine the oxygen-fuel ratio limit from one or more engine algorithms, tables, plots, or other known relationships. Therefore, the oxygen-to-fuel ratio limit may correspond to current engine speed and represent the current limits of oxygen and fuel within cylinders 44 of combustion chambers 40. The total current mass flow may represent the amount of air and EGR drawn into combustion chambers 40 and may be measured at air intake system 20 by one or more sensors (not shown). Additionally, the current EGR flow rate may represent the amount of exhaust passing through EGR flow path 97 and may be measured at EGR valve 92 by one or more sensors (not shown) in communication with controller 80.

Additionally, controller 80 may be configured to determine a maximum EGR flow rate in a closed-loop manner from a second group of operating parameters associated with power system 5. The maximum EGR flow rate may comprise a dynamic operating parameter associated with power system 5 and may represent the maximum amount of allowed exhaust passing through EGR flow path 97 based on the current condition of power system 5. Therefore, the maximum EGR flow rate may change as one or more parameters of the second group of operating parameters varies during operation of power system 5. The second group of operating parameters may include, among other things, an oxygen-to-fuel ratio limit, a total current mass flow, and/or an amount of fuel requested by governor 70. The oxygen-to-fuel ratio limit may be characterized by an oxygen amount and a fuel amount associated with one or more cylinders 44 of combustion chambers 40. Controller 80 may determine this limit from an oxygen-to-fuel ratio v. engine speed look-up map. Alternatively, controller 80 may determine the oxygen-fuel ratio limit from one or more engine algorithms, tables, plots, or other known relationships. Therefore, the oxygen-to-fuel ratio limit may correspond to current engine speed and represent the current limits of oxygen and fuel within cylinders 44 of combustion chambers 40. The total current mass flow may represent the amount of air drawn into combustion chambers 40 and may be measured at air intake system 20 by one or more sensors (not shown) in communication with controller 80. Furthermore, the amount of fuel requested by governor 70 may be based on current engine speed as discussed above.

In exemplary embodiments, the first and second groups of operating parameters may comprise at least one operating parameter in common. For example, the at least one common operating parameter may include an oxygen-to-fuel ratio limit and/or a total current mass flow. In one exemplary embodiment, the oxygen-to-fuel ratio limit for the first group of operating parameters may be equivalent to the oxygen-to-fuel ratio limit for the second group of operating parameters. In other exemplary embodiments, the oxygen-to-fuel ratio for the first and second group of operating parameters may be equivalent, except the oxygen-to-fuel ratio limit for the second group of operating parameters may be determined using an offset value. For example, in determining the oxygen-to fuel ratio limit for the second group, controller 80 may add a predetermined offset value to increase the oxygen-to-fuel ratio limit of the second group. Therefore, controller 80 may use a first oxygen-to-fuel ratio limit associated with the maximum fuel injection flow rate and a second oxygen-to-fuel ratio limit associated with the maximum EGR flow rate, wherein the second oxygen-to-fuel ratio limit is greater than the first oxygen-to-fuel ratio limit. Therefore, the first oxygen-to-fuel ratio may be less than the second oxygen-to-fuel ratio limit. As a result, the maximum EGR flow rate may comprise an altered value that is a lower value than without the offset value.

Alternatively or additionally, the total current mass flow for the first group of operating parameters may be equivalent to the total current mass flow for the second group of operating parameters. In some embodiments, the total current mass flow for the second group of operating parameters may be determined using an offset value. For example, in determining the total current mass flow for the second group, controller 80 may add a predetermined offset value to increase the total current mass flow of the second group. Therefore, controller 80 may use a higher total current mass flow to determine the maximum EGR flow rate than to determine the maximum fuel injection flow rate. As a result, the maximum EGR flow rate may comprise an altered value that is a lower value than without the offset value.

In some embodiments, controller 80 may subtract a predetermined offset value from the maximum EGR flow rate. As a result, the maximum EGR flow rate may comprise an altered value that is a lower value than without the offset value.

In order to regulate the current fuel injection flow rate, controller 80 may be configured to receive a fuel injection flow request associated with fuel injectors 55. As will be described in greater detail below with respect to FIG. 2, controller 80 may be configured to determine an amount of fuel currently requested by governor 70 based on a torque demand. Controller 80 may then compare the fuel injection flow request with the maximum fuel injection flow rate and may limit the current fuel injection flow rate accordingly.

In order to regulate the current EGR flow rate, controller 80 may be configured to receive an EGR flow request associated with EGR valve 92. As will also be described below with respect to FIG. 2, controller 80 may be configured to determine an amount of exhaust currently requested from an emission system (not shown). The requested exhaust may be re-circulated within EGR system 90. Controller 80 may then compare the EGR flow request with the maximum EGR flow rate and may limit the current EGR flow rate accordingly.

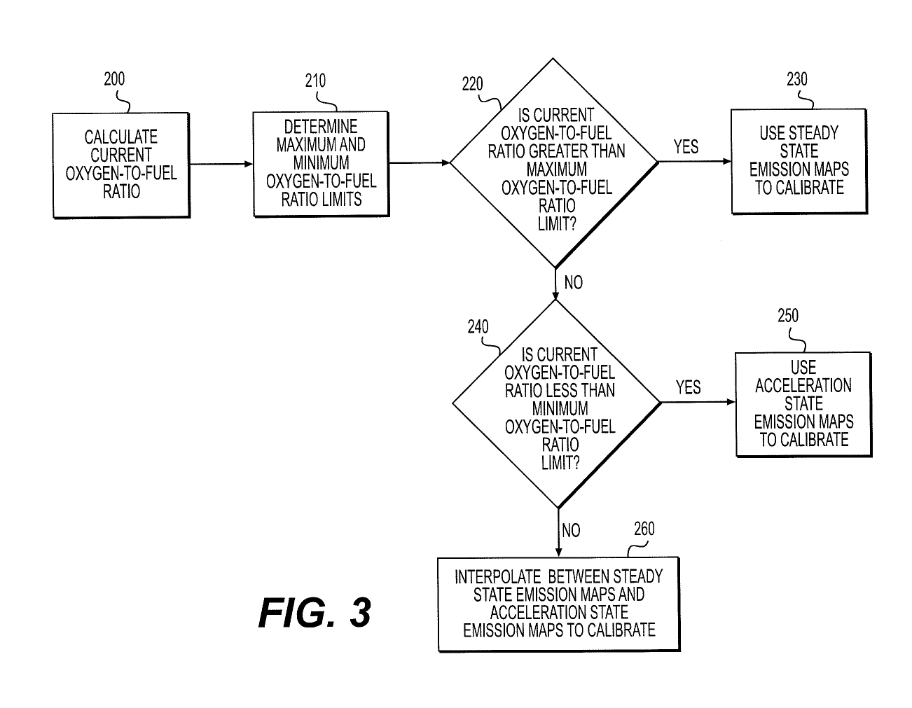

In exemplary embodiments, components of power system 5 may be calibrated based on an oxygen-to-fuel ratio. As will be described below with respect to FIG. 3, controller 80 may be configured to determine a current oxygen-to-fuel ratio associated with cylinders 44 of combustion chambers 40 from a third group of operating parameters. These operating parameters may include a current EGR flow rate, a current fuel injection flow rate, and a total current mass flow. The current EGR flow rate may represent the amount of exhaust passing through EGR flow path 97 and may be measured at EGR valve 92 by one or more sensors (not shown). The current fuel injection flow rate may represent the amount of fuel injected into combustion chambers 40 and may be measured at fuel injection system 50 by one or more sensors (not shown). The total current mass flow may represent the amount of air drawn into the combustion chambers 40 and may be measured at air intake system 20 by one or more sensors (not shown).

In exemplary embodiments, the first and second groups of operating parameters may comprise at least one common operating parameter with the third group. For example, the at least one common operating parameter may include a current EGR flow rate and/or a total current mass flow.

Controller 80 may also be configured to determine maximum and minimum oxygen-to-fuel ratio limits based on a current speed of the engine. For example, the maximum and minimum oxygen-to-fuel ratio limits may represent the maximum and minimum oxygen-to-fuel ratio amounts corresponding to engine speed on an oxygen-to-fuel ratio v. engine speed look-up map. Alternatively, controller 80 may determine the oxygen-fuel ratio limits from one or more engine algorithms, tables, plots, or other known relationships. Controller 80 may modify a group of engine settings to calibrate the engine based on the current oxygen-to-fuel ratio, and the maximum and minimum oxygen-to-fuel ratio limits, as explained in greater detail below.

### INDUSTRIAL APPLICABILITY

The disclosed system 10 may include a power system 5 and a control system configured to regulate a fuel injection flow rate and an EGR flow rate based on various operating parameters associated with engine conditions. Furthermore, the control system may efficiently calibrate the power system 5. Operation of the system 10 will now be described in detail.

As illustrated in FIG. 2, controller 80 may regulate the current fuel injection flow rate and the current EGR flow rate. In step 100, controller 80 may determine current operating parameters including a first group of operating parameters and a second group of operating parameters. As noted above, the first group may include, among other things, an oxygen-to-fuel ratio limit, a total current mass flow, and/or a current EGR flow rate, and the second group may include, among other things, an oxygen-to-fuel ratio limit, a total current mass flow, and/or an amount of fuel requested by governor 70. One or more of these operating parameters may be determined by sensors positioned as needed throughout system 10. Alternatively, one or more may be calculated and/or otherwise determined by controller 80. In exemplary embodiments, controller 80 may add an offset value to the oxygen-to-fuel ratio limit in the second group to provide a reduced maximum EGR flow rate.

At step 110, maximum flow rates may be calculated from the first and second groups of operating parameters. For example, controller 80 may calculate the maximum fuel injection flow rate from the first group of operating parameters and may calculate the maximum EGR flow rate from the second group of operating parameters.

In step 120 of FIG. 2, controller 80 may determine current flow requests associated with power system 5. Specifically, controller 80 may determine a fuel injection flow request and an EGR flow request. Controller 80 may determine the amount of fuel currently requested by governor 70 and generate the fuel injection flow request. Additionally, controller 80 may determine an amount of exhaust currently requested from the emission system and generate the EGR flow request.

Controller 80 may then compare the flow rates with the flow requests in a closed-loop manner. For example, at step 130, controller 80, may determine if the fuel injection flow request is greater than the maximum fuel injection flow rate. If controller 80 determines that the fuel injection flow request is greater than the maximum fuel injection flow rate (step 130—yes), controller 80 may instruct fuel injection system 50 to set the current fuel injection flow rate to the maximum fuel injection flow rate (step 140). In exemplary embodiments, controller 80 may instruct fuel injection system 50 not to exceed the maximum fuel injection flow rate in order to maintain a maximum fuel injection flow rate. If, on the other hand, controller 80 determines that the fuel injection flow request is not greater than the maximum fuel injection flow rate (step 130—no), controller 80 may instruct fuel injection system 50 to set the current fuel injection flow rate to the fuel injection flow request (step 150). Limiting the current fuel injection flow rate to the fuel injection flow request at step 150 may have the effect of maintaining the fuel injection flow request. Controller 80 may instruct fuel injectors 55 to may remain open for shorter periods of time to limit the current fuel injection flow rate.

In step 160, controller 80 may determine if the EGR flow request is greater than the maximum EGR flow rate. If controller 80 determines that the EGR flow request is greater than the maximum EGR flow rate (step 160—yes), controller 80 may instruct EGR system 90 to set the current EGR flow rate to the maximum EGR flow rate (step 170). In exemplary embodiments, controller 80 may instruct EGR system 90 not to exceed the maximum EGR flow rate in order to maintain a maximum EGR flow rate. If, on the other hand, controller 80 determines that the EGR flow request is not greater than the maximum EGR flow rate (step 160—no), controller 80 may instruct EGR system 90 to set the current EGR flow rate to the EGR flow request (step 180). Determining that the EGR flow request is not greater than the maximum EGR flow rate may have the effect of maintaining the EGR flow request. Controller 80 may instruct EGR valve 92 to at least partially close to limit the current EGR flow rate.

By regulating the flow rates in power system 5, controller 80 may optimize engine performance during both large and small increases in engine speed and load. For example, during an acceleration event, governor 70 may request more fuel to account for a desired increase in speed. Accordingly, fuel injection system 50 may inject more fuel into combustion chambers 40 and EGR system 90 may direct more exhaust to air intake system 20. This may result in a reduced oxygen-to-fuel ratio limit (less air compared with fuel). A decrease in the oxygen-to-fuel ratio limit may reduce the maximum fuel injection flow rate and maximum EGR flow rate. Since controller 80 may not allow the current flow rates to exceed these maximum flow rates, the current fuel injection flow rate and current EGR flow rate may correspondingly decrease. Therefore, controller 80 may maintain the current fuel injection flow rate and current EGR flow rate at levels that allow power system 5 to re-balance the oxygen-to-fuel ratio during large and small acceleration events.

Additionally, during increases in engine speed or load, controller 80 may allow EGR system 90 to reduce the amount of re-circulated exhaust before fuel injection system 50 is limited. The offset value, for example the predetermined offset value added to the oxygen-to-fuel ratio for the maximum EGR flow rate, may allow controller 80 to decrease the current EGR flow rate before the current fuel injection flow rate reaches the maximum fuel injection flow rate. During large or small acceleration events, as more exhaust and less air is present in power system 5, the oxygen-to-fuel ratio may decrease causing the maximum EGR flow rate to decrease more than the maximum fuel injection flow rate. Therefore, the current EGR flow rate may reach the maximum EGR flow rate before the current fuel injection flow rate reaches the maximum fuel injection flow rate. Controller 80 may then instruct EGR valve 92 to at least partially close and decrease the EGR flow rate when the current EGR flow rate reaches the maximum EGR flow rate. This may occur prior to the current fuel injection flow rate reaching the maximum fuel injection flow rate so that fuel injectors 55 remain open. This preemptively allows power system 5 to reduce the amount of EGR flow before the fuel injected into combustion chambers 40 is limited.

As shown in FIG. 3, controller 80 may calibrate a group of engine settings, including among other things injection timing, injection pressure, and/or shot mode. For example, controller 80 may modify the group of engine settings based on at least one or more relationships associated with the current oxygen-to-fuel ratio and the maximum and minimum oxygen-to-fuel ratio limits. In step 200, controller 80 of power system 5 may determine a current oxygen-to-fuel ratio using a third group of operating parameters. These operating parameters may include, among other things, a current EGR flow rate, a current fuel injection flow rate, and/or a total current mass flow. One or more of these operating parameters may be determined by sensors positioned as needed throughout system 10. Alternatively, controller 80 may calculate and/or otherwise determine one or more of these operating parameters.

As shown in step 210, controller 80 may additionally determine maximum and minimum oxygen-to-fuel ratio limits for power system 5 based on current engine conditions (step 210). Specifically, controller 80 may use an oxygen-to-fuel ratio v. engine speed look-up map to determine the maximum and minimum oxygen-to-fuel ratio limits. Alternatively, controller 80 may determine the maximum and minimum oxygen-fuel ratio limits from one or more engine algorithms, tables, plots, or other known relationships.

In step 220, controller 80 may determine if the current oxygen-to-fuel ratio is greater than the maximum oxygen to fuel ratio limit. If so (step 220—yes), controller 80 may modify the group of engine settings based on a first set of known relationships associated with steady state emissions conditions. For example, controller 80 may use steady state emission maps to calibrate the engine settings (step 230). Therefore, power system 5 may perform most efficiently during steady state operations. If, on the other hand, the current oxygen-to-fuel ratio limit is not greater than the maximum oxygen-to-fuel ratio limit (step 220—no), controller 80 may then determine if the current oxygen-to-fuel ratio is less than the minimum oxygen-to-fuel ratio limit, as shown in step 240. If so (step 240—yes), controller 80 may modify the group of engine settings based on a second set of known relationships associated with acceleration state emissions conditions. For example, controller 80 may instruct power system 5 to use acceleration state emission maps to calibrate engine settings (step 250). Therefore, power system 5 may perform most efficiently during acceleration state operations. If the current oxygen-to-fuel ratio is not less than the minimum oxygen-to-fuel ratio limit (step 240—no), controller 80 may modify a group of engine settings based on both the first and second sets of known relationships. For example, controller 80 may interpolate between the steady state emission maps and acceleration maps to calibrate the engine settings (step 260).

By determining the proper emissions map, controller 80 may reduce response time and emitted soot associated with power system 5. Additionally, controller 80 may provide an intuitive system to alter calibrated engine settings. For example, a user may alter the current oxygen-to-fuel ratio by the same amount the user desires to alter the calibrated injection timing. An increase in oxygen-to-fuel ratio may directly correspond to an increase in injection timing on the steady state and acceleration state emission maps.

The power system 5 of the present disclosure provides a control system configured to efficiently regulate fluid flow during acceleration and steady state modes. Controller 80 may reduce EGR flow before the current fuel injection flow rate has reached the maximum fuel injection flow rate, thereby allowing power system 5 to preemptively reduce re-circulated exhaust before injected fuel is limited. Therefore, power system 5 is not required to wait until the system reaches the maximum allowed fuel amount to reduce EGR flow. Power system 5 may begin to reduce the amount of exhaust flow and quickly re-balance the oxygen-to-fuel ratio before the maximum allowed amount of fuel is present. This may enable power system 5 to move between acceleration modes and steady state modes while reducing changes in fluid flow. Therefore, the control system of the present disclosure may reduce nitrogen oxides and other emissions in the exhaust and improve the efficiency of the engine.

The present disclosure also provides a control system to easily and intuitively calibrate power system 5. Controller 80 may determine which emission maps to use in calibrating engine settings of power system 5 based on the current conditions of the system. The maps provide a quick and easy resource in which to optimize engine settings. Furthermore, controller 80 allows a user to intuitively change the calibration of the engine settings by varying the oxygen-to-fuel ratio.

It will be apparent to those skilled in the art that various modifications and variations can be made to the system of the present disclosure. Other embodiments of the system will be apparent to those skilled in the art from consideration of the specification and practice of the method and system disclosed herein. It is intended that the specification and examples be considered as exemplary only, with a true scope of the disclosure being indicated by the following claims and their equivalents.

What is claimed is:

1. A system associated with an internal combustion engine, the system comprising:
a fuel injector configured to inject fuel into the engine at a current fuel injection flow rate;
an EGR valve configured to direct exhaust to the engine at a current EGR flow rate via an EGR flow path;
a controller in communication with the EGR valve and the fuel injector, the controller being configured to:
determine a maximum fuel injection flow rate based on a first group of operating parameters associated with the engine,
determine a maximum EGR flow rate based on a second group of operating parameters associated with the engine,
receive a fuel injection flow request associated with the fuel injector and an EGR flow request associated with the EGR valve;
set the current fuel injection flow rate to the maximum fuel injection flow rate if the fuel injection flow request is greater than the maximum fuel injection flow rate; and
set the current EGR flow rate to the maximum EGR flow rate if the EGR flow request is greater than the maximum EGR flow rate, wherein
the first and second groups comprise at least one common operating parameter including an oxygen-to-fuel ratio limit determined based on a speed of the engine.

2. The system of claim 1, wherein the maximum fuel injection flow rate and the maximum EGR flow rate comprise dynamic operating parameters associated with the engine.

3. The system of claim 1, wherein the oxygen-to-fuel ratio limit is characterized by an oxygen amount and a fuel amount associated with one or more cylinders of a combustion chamber.

4. The system of claim 1, wherein the first group of operating parameters further includes a total current mass flow associated with an air intake system of the engine and the current EGR flow rate.

5. The system of claim 4, wherein the second group of operating parameters further includes the total current mass flow associated with the air intake system and the fuel injection flow request, wherein the fuel injection flow request is determined based on a torque demand associated with the engine.

6. The system of claim 1, wherein the maximum EGR flow rate is determined based on the oxygen-to-fuel ratio limit and an offset value, wherein determining the maximum EGR flow rate based on the offset value results in a first oxygen-to-fuel ratio limit associated with the maximum fuel injection flow rate being less than a second oxygen-to-fuel ratio limit associated with the maximum EGR flow rate.

7. The system of claim 6, wherein operating the engine based on the second oxygen-to-fuel ratio limit associated with the maximum EGR flow rate results in a decrease in the current EGR flow rate prior to the current fuel injection flow rate reaching the maximum fuel injection flow rate.

8. The system of claim 7, wherein the decrease in the current EGR flow rate is achieved by at least partially closing the EGR valve.

9. The system of claim 1, wherein the controller is configured to set the current fuel injection flow rate to the fuel injection flow request if the fuel injection flow request is less than the maximum fuel injection flow rate and the controller is configured to set the current EGR flow rate to the EGR flow request if the EGR flow request is less than the maximum EGR flow rate.

10. A method of controlling an internal combustion engine, comprising:
determining a maximum fuel injection flow rate based on a first group of operating parameters associated with the engine;
determining a maximum EGR flow rate based on a second group of operating parameters associated with the engine;
receiving a fuel injection flow request and an EGR flow request;
setting the current fuel injection flow rate to the maximum fuel injection flow rate if the fuel injection flow request is greater than the maximum fuel injection flow rate;
and
setting the current EGR flow rate to the maximum EGR flow rate if the EGR flow request is greater than the maximum EGR flow rate, wherein
the maximum fuel injection flow rate and the maximum EGR flow rate are determined in a closed-loop manner, and the first and second groups each comprise an oxygen-to-fuel ratio limit determined based on a speed of the engine.

11. The method of claim 10, further including setting the current fuel injection flow rate to the fuel injection flow request if the fuel injection flow request is less than the maximum fuel injection flow rate and setting the current EGR flow rate to the EGR flow request if the EGR flow request is less than the maximum EGR flow rate.

12. The method of claim 10, wherein the oxygen-to-fuel ratio limit is characterized by an oxygen amount and a fuel amount associated with one or more cylinders of a combustion chamber.

13. The method of claim 10, wherein the first group of operating parameters further includes a total current mass flow associated with an air intake system of the engine and the current EGR flow rate.

14. The method of claim 13, wherein the second group of operating parameters further includes the total current mass flow associated with the air intake system and the fuel injection flow request, wherein the fuel injection flow request is determined based on a torque demand associated with the engine.

15. The method of claim 10, wherein the maximum EGR flow rate is determined based on the oxygen-to-fuel ratio limit and an offset value, wherein determining the maximum EGR flow rate based on the offset value results in a first oxygen-to-fuel ratio limit associated with the maximum fuel injection flow rate being less than a second oxygen-to-fuel ratio limit associated with the maximum EGR flow rate.

16. The method of claim 15, wherein operating the engine based on the second oxygen-to-fuel ratio limit associated with the maximum EGR flow rate results in a decrease in the current EGR flow rate prior to the current fuel injection flow rate reaching the maximum fuel injection flow rate.

17. A method of calibrating an internal combustion engine, comprising:
determining a current oxygen-to-fuel ratio associated with the engine;
determining maximum and minimum oxygen-to-fuel ratio limits based on a current speed of the engine; and
modifying a group of engine settings based on at least one of the following relationships:
a first set of known relationships associated with steady state emissions conditions, in response to determining that the current oxygen-to-fuel ratio is greater than the maximum oxygen-to-fuel ratio limit; and
a second set of known relationships associated with acceleration state emissions conditions, in response to determining that the current oxygen-to-fuel ratio is less than the minimum oxygen-to-fuel ratio limit.

18. The method of claim 17, wherein the at least one relationship further includes both the first and second sets of known relationships, in response to determining that the current oxygen-to-fuel ratio is greater than the minimum oxygen-to-fuel ratio and less than the maximum oxygen-to-fuel ratio.

19. The method of claim 18, wherein modifying the group of engine settings, based on the first and second sets of known relationships comprises interpolating between a value of the first set and a corresponding value of the second set.

20. The method of claim 17, further including determining the current oxygen-to-fuel ratio based on a current EGR flow rate, a total current mass flow associated with the engine, and a current fuel injection flow rate.
